(19) United States
(12) Patent Application Publication
(10) Pub. No.: US 2008/0065351 A1
(43) Pub. Date: Mar. 13, 2008

(54) Thickness measurement based navigation apparatus and methods

(76) Inventors: George Panotopoulos, Santa Clara, CA (US); David W. Dolfi, Los Altos, CA (US)

Correspondence Address: Kathy Manke;Avago Technologies Limited, 4380 Ziegler Road, Fort Collins, CO, 80525, US

(21) Appl. No.: 11/518,709

(22) Filed: Sep. 11, 2006

(51) Int. Cl. G06F 19/00; G01B 11/02; G06F 17/40

(52) U.S. Cl. 702/170; 702/1; 702/127; 702/189; 702/187; 702/155

(57) ABSTRACT

Thickness measurement based navigation apparatus and methods are described. An apparatus includes a thickness sensor system and a processing system. The thickness sensor system produces a respective set of measurements of thickness of an object at six or more locations through a surface of the object during each of multiple thickness measurement cycles. The processing system produces motion measures indicative of movement in relation to the object from ones of the sets of thickness measurements. In accordance with a method, a respective set of measurements of thickness of an object is generated at six or more locations through a surface of the object during each of multiple thickness measurement cycles. Motion measures indicative of movement in relation to the object are generated from ones of the sets of thickness measurements.

### BACKGROUND

Many different types of devices have been developed for inputting commands into a machine. For example, hand-manipulated input devices, such as computer mice, joysticks, trackballs, touchpads, and keyboards, commonly are used to input instructions and/or data into a computer by manipulating the input device. Such input devices allow a user to control movement of a virtual pointer, such as a cursor, across a computer screen, select or move an icon or other virtual object displayed on the computer screen, and open and close menu items corresponding to different input commands. Input devices commonly are used in both desktop computer systems and portable computing systems.

Input devices typically include a mechanism for converting a user input into user interface control signals, such as cursor position data and scrolling position and distance data. Although some types of input device use electromechanical transducers to convert user manipulation of the input device into user interface control signals, input devices developed most recently use optical navigation sensors to convert user manipulation of the input device into user interface control signals. The optical navigation sensors employ optical navigation technology that measures changes in position by acquiring a sequence of images of a surface and mathematically determining the direction and magnitude of movement over the surface from comparisons of corresponding features in the images. Such optical navigation systems typically track the scanned path of the input device based on detected pixel-to-pixel surface reflectivity differences that are captured in the images. These changes in reflectivity may be quite small depending upon the surface medium (e.g., on the order of 6% for white paper).

One problem with existing optical navigation sensors is that they are unable to navigate well on very smooth surfaces, such as glass, because the images reflected from such surfaces are insufficiently different to enable the direction and magnitude of movement over the surface to be determined reliably. In an attempt to solve this problem, optical navigation sensors have been proposed that illuminate smooth-surfaced objects with coherent light. Optical nonuniformities in or on the objects induce phase variations in the illuminating light that can be detected by an interferometric optical navigation sensor. Optical navigation sensors of this type include an interferometer that converts the phase patterns into interference patterns (or interferograms) that are used to determine relative movement with respect to the objects. Although this approach improves navigation performance over specular surfaces, uniform surfaces, and surfaces with shallow features, this approach relies on optical nonuniformities, such as scratches, imperfections, and particulate matter in or on the surface to produce the phase patterns that are converted into the interferograms by the component interferometers. As a result, this approach is unable to navigate reliably over surfaces that are free of such features.

What are needed are input systems and methods that are capable of accurately navigating over different types of surfaces, such as, opaque surfaces, is specular surfaces, smooth surfaces containing optical nonuniformities, and smooth surfaces that are free of nonuniformities.

### SUMMARY

In one aspect, the invention features an apparatus that includes a thickness sensor system and a processing system. The thickness sensor system produces a respective set of measurements of thickness of an object at six or more locations through a surface of the object during each of multiple thickness measurement cycles. The processing system produces motion measures indicative of movement in relation to the object from ones of the sets of thickness measurements.

In one aspect, the invention features a method in accordance with which a respective set of measurements of thickness of an object is generated at six or more locations through a surface of the object during each of multiple thickness measurement cycles. Motion measures indicative of movement in relation to the object are generated from ones of the sets of thickness measurements.

Other features and advantages of the invention will become apparent from the following description, including the drawings and the claims.

### DESCRIPTION OF DRAWINGS

FIG. 1 is a block diagram of an embodiment of a navigation apparatus that includes a thickness sensor system and a processing system in an exemplary operational environment.

FIG. 2 is a flow diagram of an embodiment of a navigation method.

FIG. 3 is a block diagram of an embodiment of the navigation apparatus shown in FIG. 1.

FIG. 4 is a diagrammatic top view of an embodiment of a thickness sensor system that includes six thickness sensors arranged in first and second measurement groups.

FIG. 5 is a tabular representation of an embodiment of a position map.

FIG. 6 is a flow diagram of an embodiment of a method of generating an embodiment of a position map.

FIG. 7 is a flow diagram of an embodiment of a navigation method.

FIG. 8 is a tabular representation of the position map shown in FIG. 5 in which a set of position coordinates and an associated set of thickness values are highlighted.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

### I. OVERVIEW

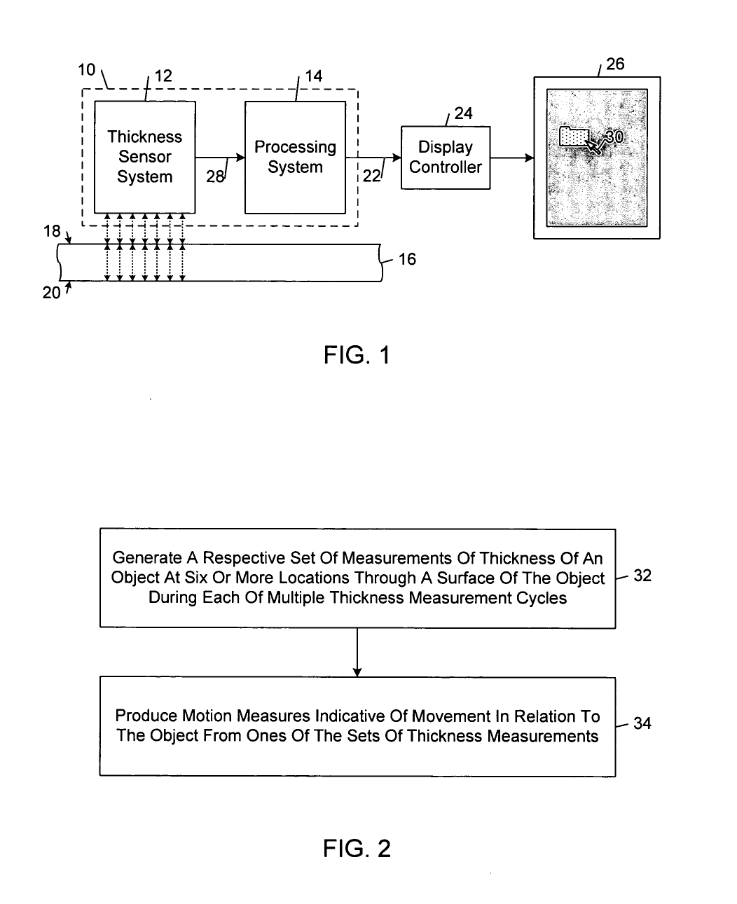

FIG. 1 shows an embodiment of a navigation apparatus 10 that includes a thickness sensor system 12 and a processing system 14. As explained in detail below, the navigation apparatus 10 is able to navigate over objects based on thickness measurements. In this way, the navigation apparatus is able to navigate over any type of object whose thickness can be measured, including objects that are difficult to navigate over using traditional optical navigation techniques, such as transparent objects with smooth surfaces that are free of surface and/or volume nonuniformities. For illustrative purposes, the operation of the navigation apparatus 10 is described herein with respect to an object 16, which has smooth front and back surfaces 18, 20.

In general, the navigation apparatus 10 may be incorporated into any type of device or system in which sensing motion or position serves a useful purpose. For illustrative purposes, the navigation apparatus 10 is described herein as a component of a device for inputting commands into a machine, where the input device may have any of a wide variety of different form factors, including a computer mouse, a joystick, a trackball, and a steering wheel controller. In these implementations, the navigation apparatus 10 may be configured to sense user manipulations of a component of the input device (e.g., a touch pad, a trackball, or a joystick) or manipulations of the input device itself (e.g., movement of the input device across a surface).

In the illustrative operational environment shown in FIG. 1, the navigation apparatus 10 outputs display control signals 22 to a display controller 24 that drives a display 26. The display control signals 22 typically are in the form of motion measures that are derived from thickness measurements 28 that are produced by the thickness sensor system 12. The motion measures typically correspond to one or more of position parameter values, displacement parameter values, velocity parameter values, and acceleration parameter values. The display controller 24 processes the display control signals 22 to control, for example, the movement of a pointer 30 on the display 26. The display controller 24 typically executes a driver to process the display control signals 22. In general, the driver may be implemented in any computing or processing environment, including in digital electronic circuitry or in computer hardware, firmware, or software. In some embodiments, the driver is a component of an operating system or a software application program. The display 26 may be, for example, a flat panel display, such as a LCD (liquid crystal display), a plasma display, an EL display (electro-luminescent display) and a FED (field emission display).

In some embodiments, the navigation apparatus 10 and the display 26 are implemented as separate discrete devices, such as a separate pointing device and a remote display-based system. In these embodiments, the remote system may be any type of display-based appliance that receives user input, including a general-purpose computer system, a special-purpose computer system, and a video game system. The display control signals 22 may be transmitted to the remote system over a wired communication link (e.g., a serial communication link, such as an RS-232 serial port, a universal serial bus, or a PS/2 port) or a wireless communication link (e.g., an infrared (IR) wireless link or a radio frequency (RF) wireless link). In other embodiments, the navigation apparatus 10 and the display 26 are integrated into a single unitary device, such as a portable (e.g., handheld) electronic device. The portable electronic device may be any type of device that can be readily carried by a person, including a cellular telephone, a cordless telephone, a pager, a personal digital assistant (PDA), a digital audio player, a digital camera, and a digital video game console.

FIG. 2 shows a flow diagram of an embodiment of a navigation method that is implemented by the navigation apparatus 10 shown in FIG. 1.

In accordance with this method, the thickness sensor system 12 generates a respective set of measurements 28 of thickness of the object 16 at six or more locations through a front surface 18 of the object 16 during each of multiple thickness measurement cycles (FIG. 2, block 32). In general, the thickness measurements 28 may be produced in accordance with any type of non-contact thickness measurement process, including optical thickness measurement processes and non-optical thickness measurement processes. Exemplary optical thickness measurement processes are based on triangulation, depth of focus, Moiré fringes, and interferometry. Exemplary non-optical thickness measurement processes include ultrasonic processes that measure thickness based on the time delay between ultrasonic echoes from front and back surfaces 18, 20 of the object 16, and magnetic thickness measurement processes that are based on measurement of eddy currents or magnetic induction.

The processing system 14 produces motion measures that are indicative of movement in relation to the object 16 from ones of the sets of thickness measurements 28 (FIG. 2, block 34). As explained in detail below, in some embodiments, the processing system 14 produces the motion measures from estimates of the slope of the thickness of the object 16 at two or more locations through the object surface 18 in at least two directions. The processing system 14 determines the displacement of the navigation apparatus 10 from one measurement cycle to the next measurement cycle based on the thickness slope estimates and the changes in the measured thicknesses at the two or more locations through the object surface 18. In some embodiments, the processing system 14 determines the velocity of the navigation apparatus by multiplying the displacement measures by the measurement cycle rate (i.e., the thickness measurement sampling rate).

The processing system 14 may be implemented by one or more discrete modules that are not limited to any particular hardware or software configuration. The one or more modules may be implemented in any computing or processing environment, including in digital electronic circuitry (e.g., an application-specific integrated circuit, such as a digital signal processor (DSP)) or in computer hardware, firmware, device driver, or software.

In some implementations, computer process instructions for implementing the modules of the process system 14 and the data generated by these modules are stored in one or more machine-readable media. Storage devices suitable for tangibly embodying these instructions and data include all forms of non-volatile memory, including, for example, semiconductor memory devices, such as EPROM, EEPROM, and flash memory devices, magnetic disks such as internal hard disks and removable disks, magneto-optical disks, and CD/DVD-ROM.

### II. EXEMPLARY EMBODIMENTS OF THE NAVIGATION APPARATUS

A. Exemplary Thickness Sensor System Embodiments

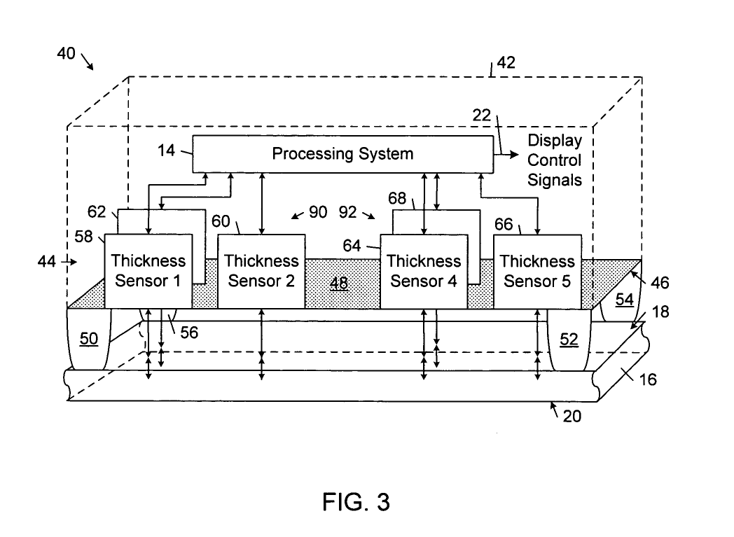

FIG. 3 shows an embodiment 40 of the navigation apparatus 10 that includes a housing 42 that contains an embodiment 44 of the thickness sensor system 12 and the processing system 14. The housing 42 additionally includes a bottom side 46 that is configured to slide over the front surface 18 of the object 16 (e.g., a glass substrate). In this regard, the bottom side 46 supports a set of sliders 50, 52, 54, 56, which have low friction surfaces that facilitate sliding over the front surface 18. The thickness sensor system 44 includes six thickness sensors 58, 60, 62, 64, 66, 68, which are coplanar on a substrate 48 within the housing 42.

In some embodiments, the thickness sensors are arranged in at least a first measurement group and a second measurement group, where the first and second measurement groups are disjoint and include respective sets of at least three of the thickness sensors. The thickness sensors in each measurement group produce respective thickness measurements at different respective non-collinear locations through the object surface during each of the thickness measurement cycles. In some of these embodiments, at least two of the thickness sensors in the first measurement group are collinear along a line parallel to a first coordinate axis and at least two of the thickness sensors in the first measurement group are collinear along a line parallel to a second coordinate axis different from the first coordinate axis. In addition, at least two of the thickness sensors in the second measurement group are collinear along a line parallel to the first coordinate axis and at least two of the thickness sensors in the second measurement group are collinear along a line parallel to the second coordinate axis; In general, the first and second coordinate axes may be oriented along any nonparallel directions. In some embodiments, the first and second coordinate axes are orthogonal.

In the embodiment shown in FIGS. 3 and 5, the thickness sensors 58-68 are arranged in a first measurement group 90 and a second measurement group 92, which are disjoint. The first measurement group consists of thickness sensors 58-62 and the second measurement group 92 consists of thickness sensors 64-68. The thickness sensors in each group 90, 92 produce respective thickness measurements at different respective non-collinear locations through the front surface 18 of the object 16 during each of the thickness measurement cycles. In this regard, the thickness sensors 58 and 60 in the first measurement group 90 are collinear along a line parallel to a first coordinate axis (i.e., the u-axis) and the thickness sensors 58 and 60 in the first measurement group 90 are collinear along a line parallel to a second coordinate axis (i.e., the v-axis), which is orthogonal to the first coordinate axis. Similarly, the thickness sensors 64 and 66 in the second measurement group 92 are collinear along a line parallel to the u-axis and the thickness sensors 64 and 68 in the second measurement group 92 are collinear along a line parallel to the v-axis.

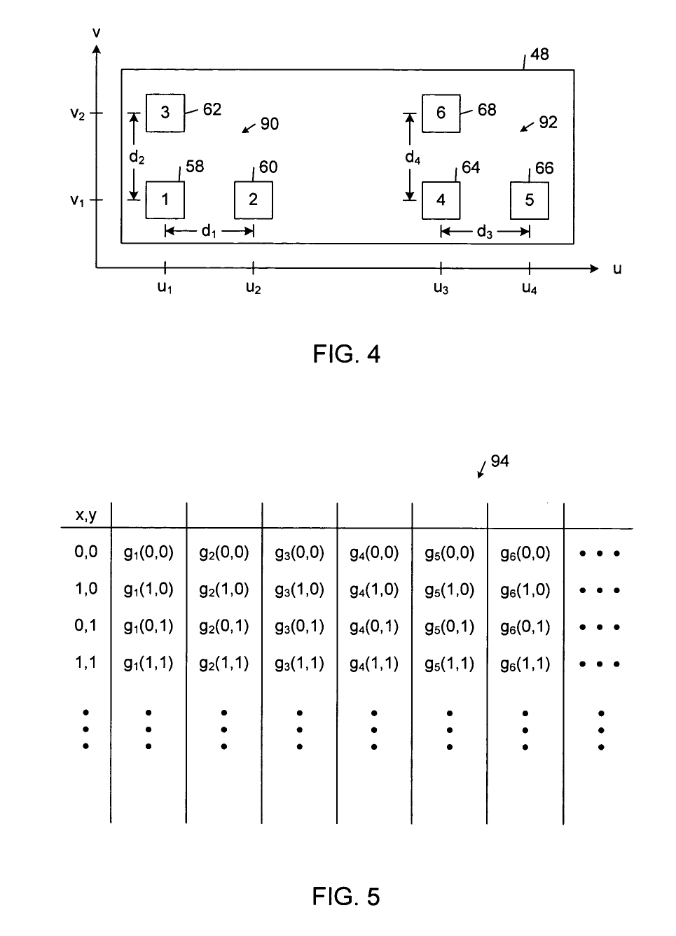

Referring to FIG. 4, the thickness sensors 58-68 are mounted on the substrate 48 with fixed spacings between the thickness sensors. Thickness sensors 58 and 60 are separated by a distance d₁, thickness sensors 58 and 62 are separated by a distance d₂, thickness sensors 64 and 66 are separated by a distance d₃, and thickness sensors 64 and 68 are separated by a distance d₄. In general, the separation distances d₁, d₂, d₃, d₄ may have the same values or different values. In the illustrated embodiment, the separation distances d₁, d₂, d₃, d₄ all have the same value (i.e., d₁=d₂=d₃=d₄).

B. Exemplary Local Approximation Based Methods of Determining Motion Measures from Thickness Measurements

In some embodiments, the processing system 14 determines the motion measures based on local approximations of the surface thickness function h(x,y) of the object 16 as a function of location (x,y) on the front surface 18 in the vicinity of at least two of the sampling points (i.e., the locations through the front surface 18 where the thickness measurements are made) during a given measurement cycle. In embodiments in which the thickness sensors are segmented into different measurement groups, a respective local approximation of the thickness of the object is determined for at least one sampling point that is measured by a corresponding thickness sensor in each measurement group.

In general, the processing system 14 may use any type of local approximation, including approximations based on zeroth-order function information, approximations based on first-order function information, and approximations based on higher-order function information. In some embodiments, these local approximations are based on a Taylor series expansion of the thickness function h(x,y). In some of these embodiments, the processing system 14 approximates the thickness function h(x,y) locally using the following linear approximation \tilde{h}(x,y) based on the Taylor series:

$$\tilde{h} ( x , y ) = h ( {x}_{0} , {y}_{0} ) + ( x - {x}_{0} ) \cdot {( \frac{\partial h}{\partial x} )}_{( {x}_{0} , {y}_{0} )} + ( y - {y}_{0} ) \cdot {( \frac{\partial h}{\partial y} )}_{( {x}_{0} , {y}_{0} )} \qquad ( 1 )$$

where (x₀,y₀) is the location of the initial point sampled during a first measurement cycle and (x,y) is the location of the second point sampled during a second measurement cycle. In this formulation, the x and y coordinate axes correspond to the u and v coordinate axes that are defined by the locations of the thickness sensors in the navigation apparatus. In the illustrate embodiments, the coordinate axes of the sensor (i.e., the u-v axes) and the coordinate axes of the movement of the navigation apparatus 10 are the same. In other embodiments, the u-v coordinate system and the x-y coordinate system may be oriented at a non-zero angle with respect to one another. In addition, the u-v coordinate axes may be oriented at any angle with respect to each other so long as they are not parallel. For example, the u-v coordinate axes may be orthogonal to one another as shown in FIG. 4 or they may be oriented at a non-orthogonal angle greater than zero.

The processing system 14 determines values for the displacement parameters (x-x₀) and (y-y₀) based on thickness measurements that are obtained during the two different measurement cycles. In this process, the first derivatives of the thickness function h(x,y) along the x and y directions are linearly approximated by the differences between adjacent ones of the thickness sensors divided by the known distances separating the adjacent thickness sensors. With respect to the navigation apparatus 40, the first derivatives at location (x₁,y₁) corresponding to the projection of the location of thickness sensor 58 (sensor 1) are given by:

$$\begin{matrix}{( \frac{\partial h}{\partial x} )}_{( {x}_{1} , {y}_{1} )} = \frac{{H}_{2} - {H}_{1}}{{d}_{1}} & ( 2 ) \\ {( \frac{\partial h}{\partial y} )}_{( {x}_{1} , {y}_{1} )} = \frac{{H}_{3} - {H}_{1}}{{d}_{2}} & ( 3 )\end{matrix}$$

where Hᵢ is the thickness measured by sensor i during the first measurement cycle. Similarly, the first derivatives at location (x₃,y₁) corresponding to the projection of the location of thickness sensor 64 (sensor 3) are given by:

$$\begin{matrix}{( \frac{\partial h}{\partial x} )}_{( {x}_{3} , {y}_{1} )} = \frac{{H}_{5} - {H}_{4}}{{d}_{3}} & ( 4 ) \\ {( \frac{\partial h}{\partial y} )}_{( {x}_{3} , {y}_{1} )} = \frac{{H}_{6} - {H}_{4}}{{d}_{4}} & ( 5 )\end{matrix}$$

Equations (1)-(5) can be combined to obtain the following system of two linear equations, which are functions of the two displacement parameter values Δx≡x−x₀ and Δy≡y−y₀:

$$\begin{matrix}{\tilde{H}}_{1} = {H}_{1} + Δ x \cdot ( \frac{{H}_{2} - {H}_{1}}{{d}_{1}} ) + Δ y \cdot ( \frac{{H}_{3} - {H}_{1}}{{d}_{2}} ) & ( 6 ) \\ {\tilde{H}}_{3} = {H}_{3} + Δ x \cdot ( \frac{{H}_{5} - {H}_{4}}{{d}_{3}} ) + Δ y \cdot ( \frac{{H}_{6} - {H}_{4}}{{d}_{4}} ) & ( 7 )\end{matrix}$$

where \tilde{H}₁ is the thickness measured by sensor 1 during the subsequent measurement cycle and \tilde{H}₃ is the thickness measured by sensor 3 during the subsequent measurement cycle. The processing system 14 may determine the values of the displacement parameters Δx and Δy using any one or a wide variety of methods, including Cramer's rule.

The processing system 14 may produce ones of display control signals 22 that correspond to changes in the relative positions of the navigation apparatus in relation to the object 16 based on the determined displacement parameter values. As explained above, some embodiments of the processing system 14 determines the velocity of the navigation apparatus by multiplying the displacement parameter values by the measurement cycle rate (i.e., the thickness measurement sampling rate).

C. Exemplary Position Map Based Navigation Apparatus

In some embodiments, the processing system 14 determines a set of position coordinates in relation to the object 16 based on the motion measures that are determined in accordance with the embodiments described above. In this regard, the processing system 14 determines the position coordinates with respect to a origin position, which may correspond to the initial startup position of the navigation apparatus or the initial position of the navigation apparatus after being lifted off and placed back down onto the front surface 18 of the object 16. Each current position coordinate x(n), y(n) represents the position of the navigation apparatus on the front surface 18 of the object 16 in relation to the designated origin during the current measurement cycle n. Each set of current position coordinates typically is determined from a displacement from the preceding position coordinates x(n−1), y(n−1) that were determined during the previous measurement cycle n−1 in accordance with equations (8) and (9):

x(n)=x(n−1)+Δx|ₙ (8)

y(n)=y(n−1)+Δy|ₙ (9)

In some embodiments, the processing system 14 generates a position map that can be used to generate the display control signals 22 from the recorded position coordinates and their associated thickness measurements. The position map is a data structure that includes the position coordinates x, y that are determined by the processing system 14 from the motion measures and are indexed by respective sets of thickness values that are derived from corresponding ones of the sets of thickness measurements produced by the thickness sensors during respective measurement cycles.

FIG. 5 shows an exemplary tabular representation of an embodiment of a position map 94 in which each of the position coordinate locations (x₁,yⱼ) is indexed by a respective vector \vec{G}(xᵢ,yᵢ)={g₁(xᵢ,yⱼ), g₂(xᵢ, yⱼ), . . . , gₖ(xᵢ,yⱼ)} where i and j are positive integers that index the x and y position coordinate locations for x and y, and k is a positive integer that corresponds to the number of the thickness sensors whose measurements are used to generate the position map 94. In general, k is less than or equal to the total number of thickness sensors in the navigation apparatus.

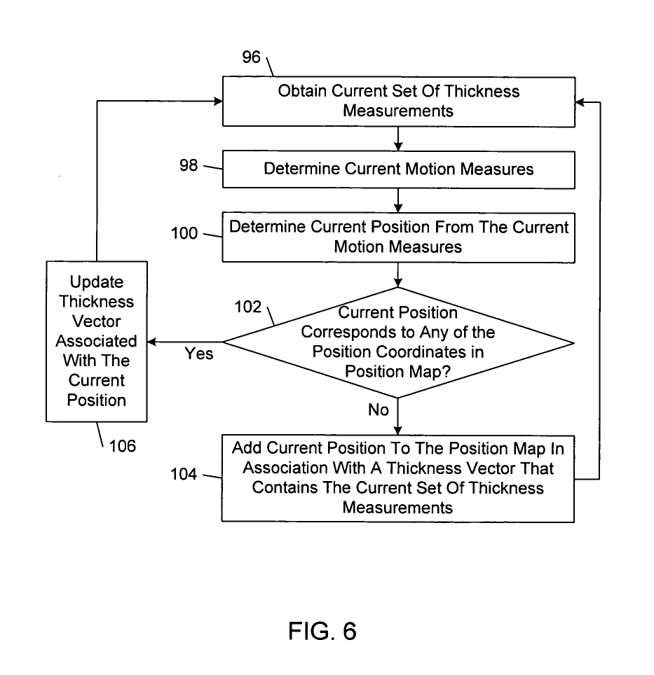

FIG. 6 shows a method that is executed by an embodiment of the processing system 14 in order to generate the position map 94.

In accordance with this method, the processing system 14 obtains the current set of thickness measurements {hₚ(xᵢ,yⱼ,n)} for measurement cycle n, where p has a positive integer value that corresponds to the thickness sensor index (FIG. 6, block 96). The processing system 14 determines the current motion measures in accordance with the embodiments that are described in the preceding section (FIG. 6, block 98). The processing system 14 then determines the current position (xᵢ,yⱼ) of the navigation apparatus from the current motion measures in accordance with the process described above in connection with equations (8) and (9) (FIG. 6, block 100).

If the current position (xᵢ,yⱼ) does not correspond to any of the positions in the position map 94 (FIG. 6, block 102), the processing system 14 adds the current position (xᵢ,yⱼ) to the position map 94 in association with a thickness vector \vec{G}(xᵢ,yᵢ) that corresponds to the current set of thickness measurements {hₚ(xᵢ,yⱼ,n)} (FIG. 6, block 104).

If the current position coordinate corresponds to a position (xᵢ,yⱼ) in the position map 94 (FIG. 6, block 102), the processing system 14 updates the thickness vector \vec{G}(xᵢ,yᵢ) that is associated with the current position (xᵢ,yⱼ) (FIG. 6, block 106). In some embodiments, the processing system 14 derives values for the thickness parameters in each vector \vec{G}(xᵢ,yᵢ) during a current measurement cycle n from a weighted combination of the sets of thickness measurements that are produced during previous measurement cycles and are determined to have the same position coordinates (xᵢ,yⱼ). In some of these embodiments, the processing system 14 updates the thickness parameter value gₚ(xᵢ,yⱼ, n−1) in accordance with equation (10) to produce the current thickness parameter value gₚ(xᵢ,yⱼ,n):

gₚ(xᵢ,yⱼ,n)=αₙ·hₚ(xᵢ,yⱼ,n)+(1−αₙ)·gₚ(xᵢ,yⱼ,n−1) (10)

where p has a positive integer value that corresponds to the thickness sensor index, αₙ corresponds to the weight that is applied to the difference between the current thickness measurement hₚ(xᵢ,yⱼ,n) and thickness parameter value gₚ(xᵢ,yⱼ,n−1) during the previous measurement cycle n−1 at position coordinate (xᵢ,yⱼ). If the navigation apparatus does not produce a thickness measurement at position coordinate (xᵢ,yⱼ) during measurement cycle n, the value of gₚ(xᵢ,yⱼ,n−1) is not updated. In some embodiments, the weights αₙ decrease with the number of measurement cycles since the current original was selected.

The resulting position map 94 allows the processing system 14 to determine a one-to-one mapping between the location of the navigation apparatus in relation to the object 16 and coordinates on the display 26 (see FIG. 1). In this way, the navigation apparatus may be configured to display control signals based on absolute positions of the navigation apparatus. The position map 94 also may be used to determine relative motion measures based on differences between the absolute position coordinates.

In some embodiments, the processing system 14 resets the thickness map in response to a determination that the navigation apparatus has been lifted off the navigation surface for which the current thickness map was generated and moved to a new location on the same navigation surface or moved to a different navigation surface.

In the case where the navigation apparatus has been lifted off the navigation surface and moved to a new location on the same navigation surface, the processing system redefines the origin of a new thickness map as the location where the navigation apparatus initially is placed at the new location. In some embodiments, if the new origin position corresponds to an identifiable position in the previous thickness map, the processing system 14 is operable to translate at least a portion of the previous thickness map with respect to the new origin position and, thereby, avoid having to recalculate the position coordinates in the translated portion of the previous thickness map.

In the case where the navigation apparatus has been moved to a different navigation surface, the processing system 14 determines a new thickness map for the current navigation surface. The origin of the new thickness map is located where the navigation apparatus initially is placed on the new navigation surface. In some of these embodiments, the processing system 14 stores a different respective thickness map for different navigation surfaces.

The user can also instruct processing system 14 to reset the thickness map by providing the corresponding instruction, either by applying pressure on button (draw on figure and number), or using software.

D. Exemplary Position Map Based Methods of Determining Motion Measures from Thickness Measurements

In some embodiments, once the changes in all the thickness parameter values gₚ(xᵢ,yⱼ) have converged (e.g., after the changes resulting from successive updates fall below a threshold value), the processing system 14 discontinues the position map building process shown in FIG. 6. At this point, the process system 14 may use the resulting position map 94 to complement or replace navigation based on the local approximation based methods of determining motion measures that are described above.

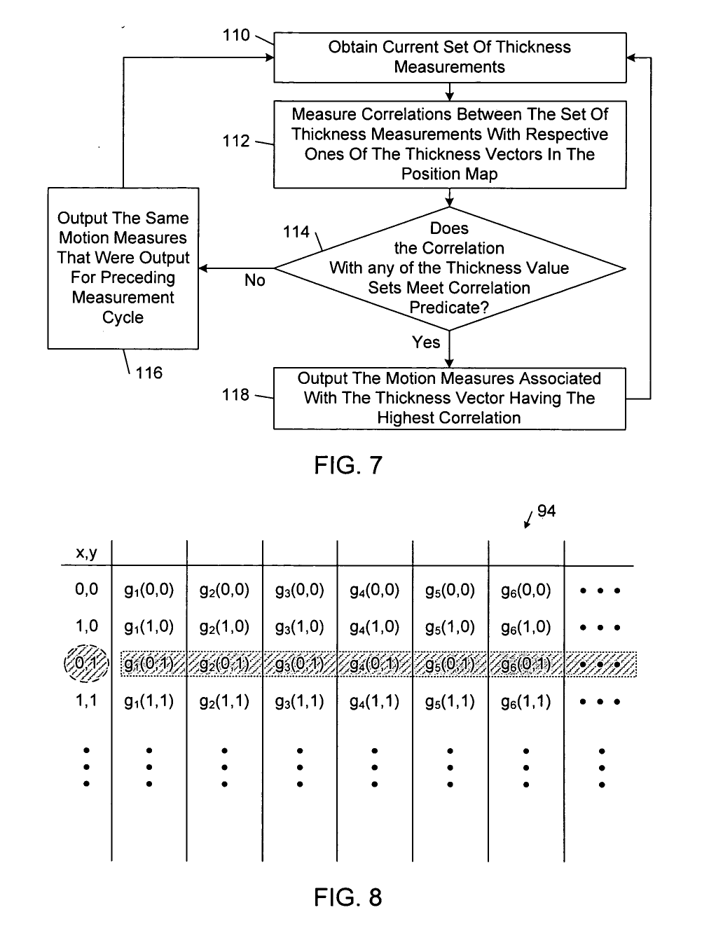

FIG. 7 shows an embodiment of a navigation method that is executed by the navigation apparatus to generate the display control signals 22 based on the position coordinates that are indexed in the position map 94.

In accordance with this method, the processing system 14 obtains the current set of thickness measurements {hₚ(n)} for measurement cycle n, where p has a positive integer value that corresponds to the thickness sensor index (FIG. 7, block 110). The processing system 14 measures correlations between the current set of thickness measurements {hₚ(n)} and respective ones of the thickness vectors \vec{G}(xᵢ,yᵢ) in the position map 94 (FIG. 7, block 112).

In general, any of a wide variety of different vector correlation methods may be used to measure the correlation between the current set of thickness measurements {hₚ(n)} and the thickness vectors \vec{G}(xᵢ, yᵢ). In some embodiments, the processing system 14 determines a distance between the current set of thickness measurements {hₚ(n)} and each of the thickness vectors \vec{G}(xᵢ,yᵢ) corresponding to one of the vector norms f_{L}(xᵢ,yⱼ) of the type defined by equation (11):

$${f}_{L} ( {x}_{i} , {y}_{j} ) = {( {\sum }_{i}^{k} {\vert {h}_{i} - {g}_{i} ( {x}_{i} , {y}_{j} ) \vert}^{L} )}^{\frac{1}{L}} \qquad ( 11 )$$

where L corresponds to a positive integer that specifies the type of vector norm. The vector norm for L=1 typically is referred to as the L1-norm and the vector norm for L=2 typically is referred to as the L2-norm. In some of these embodiments, the correlation predicate corresponds to a vector norm value f_{L}(xᵢ,yⱼ) that is below a specified threshold value.

If none of the correlations between the current set of thickness measurements {hₚ(n)} and the thickness vectors \vec{G}(xᵢ,yᵢ) in the position map 94 meets the specified correlation predicate (FIG. 7, block 114), the processing system 14 outputs the same motion measures that were output for a preceding measurement cycle (FIG. 7, block 116), or it outputs motion measures derived from the surface thickness function approximation.

If the correlation of the current set of thickness measurements {hₚ(n)} with at least one of the thickness vectors \vec{G}(xᵢ,yᵢ) in the position map 94 does meet the specified correlation predicate (FIG. 7, block 114), the processing system 14 outputs motion measures that are derived from the position coordinates that are associated with the thickness vector having the highest correlation with the current set of thickness measurements {hₚ(n)} (FIG. 7, block 118). In the illustrative example shown in FIG. 8, the processing system 14 outputs motion measures that are derived from the position coordinates (0,1) after determining that the thickness vector \vec{G}(0,1)={g₁(0,1), g₂(0,1), . . . , gₖ(0,1)} has the highest correlation with the current set of thickness measurements {hₚ(n)}.

In general, the processing system 14 is able to determine motion measures that describe the absolute position of the navigation apparatus in relation to the object 16 or that describe relative movement of the navigation apparatus in relation to the object 16. The absolute positions correspond to the position coordinates in the position table 94. These position coordinates may be used to establish a one-to-one correspondence between movements of the navigation apparatus in relation to the object 16 in a manner analogous to tablet-based navigation. The motion measures that describe relative movement may be derived from differences between the current absolute position of the navigation apparatus and the previous absolution position of the navigation apparatus. These motion measures may be used to perform relative position navigation in a manner analogous to traditional optical and trackball-based computer mouse navigation methods.

### III. CONCLUSION

The navigation apparatus and methods that are described herein enable navigation over objects based on measurements of the thicknesses of the objects. In this way, these embodiments enable navigation over any type of object whose thickness can be measured, including objects, such as transparent objects with smooth surfaces that are free of nonuniformities, which are difficult to navigate over using traditional optical navigation techniques.

Other embodiments are within the scope of the claims.

What is claimed is:

1. An apparatus, comprising:
a thickness sensor system operable to produce a respective set of measurements of thickness of an object at six or more locations through a surface of the object during each of multiple thickness measurement cycles; and
a processing system operable to produce motion measures indicative of movement in relation to the object from ones of the sets of thickness measurements.

2. The apparatus of claim 1, wherein the thickness sensor system contemporaneously produces the thickness measurements in each set.

3. The apparatus of claim 1, wherein the thickness sensor system comprises at least six thickness sensors each of which is operable to produce a respective one of the thickness measurements at a respective one of the locations through the object surface during each of the measurement cycles.

4. The apparatus of claim 3, wherein the thickness sensors are arranged in at least a first measurement group and a second measurement group, wherein the first and second measurement groups are disjoint and comprise respective sets of at least three of the thickness sensors that are operable to produce respective thickness measurements at different respective non-collinear locations through the object surface during each of the thickness measurement cycles.

5. The apparatus of claim 4, further comprising a substrate, wherein the thickness sensors in the first and second groups are coplanar on the substrate.

6. The apparatus of claim 4, wherein:
at least two of the thickness sensors in the first measurement group are collinear along a line parallel to a first coordinate axis and at least two of the thickness sensors in the first measurement group are collinear along a line parallel to a second coordinate axis orthogonal to the first coordinate axis; and
at least two of the thickness sensors in the second measurement group are collinear along a line parallel to the first coordinate axis and at least two of the thickness sensors in the second measurement group are collinear along a line parallel to the second coordinate axis.

7. The apparatus of claim 1, wherein the processing system is operable to determine differences between pairs of thickness measurements produced during a first one of the measurement cycles, and the processing system is operable to produce ones of the motion measures from the determined differences and ones of the thickness measurements produced during a second one of the measurement cycles different from the first measurement cycle.

8. The apparatus of claim 1, wherein the processing system is operable to determine position coordinates in relation to the object based on the motion measures.

9. The apparatus of claim 8, wherein the processing system is operable to generate a position map comprising ones of the position coordinates indexed by respective sets of thickness values derived from respective ones of the sets of thickness measurements produced by the thickness sensor system.

10. The apparatus of claim 9, wherein the processing system is operable to identify ones of the position coordinates from correlations between corresponding ones of the sets of thickness values in the position map with respective sets of thickness measurements produced by thickness sensor system, and the processing system is operable to produce ones of the motion measures based on the identified position coordinates.

11. The apparatus of claim 9, wherein the processing system is operable to derive each of the sets of thickness values from a weighted combination of the sets of thickness measurements that are determined to have corresponding position coordinates.

12. The apparatus of claim 1, wherein the processing system produces ones of the movement measures indicative of movement in relation to the object in directions along the object surface.

13. A method, comprising:
generating a respective set of measurements of thickness of an object at six or more locations through a surface of the object during each of multiple thickness measurement cycles; and
producing motion measures indicative of movement in relation to the object from ones of the sets of thickness measurements.

14. The method of claim 13, wherein the generating comprises contemporaneously producing the thickness measurements in each set.

15. The method of claim 13, wherein the generating comprises producing the thickness measurements in each set in at least a first measurement group and a second measurement group, wherein the first and second measurement groups are disjoint and comprise respective sets of at least three of the thickness measurements produced at different respective non-collinear locations through the object surface during each of the thickness measurement cycles.

16. The method of claim 15, wherein:
at least two of the thickness measurements in the first measurement group are produced at locations through the surface that are collinear along a line parallel to a first coordinate axis and at least two of the thickness measurements in the first measurement group are produced at locations through the surface that are collinear along a line parallel to a second coordinate axis nonparallel to the first coordinate axis; and
at least two of the thickness measurements in the second measurement group are produced at locations through the surface that are collinear along a line parallel to the first coordinate axis and at least two of the thickness measurements in the second measurement group are produced at locations through the surface that are collinear along a line parallel to the second coordinate axis.

17. The method of claim 13, further comprising determining differences between pairs of thickness measurements produced during a first one of the measurement cycles, and the generating comprises producing ones of the motion measures from the determined differences and ones of the thickness measurements produced during a second one of the measurement cycles different from the first measurement cycle.

18. The method of claim 13, further comprising determining position coordinates in relation to the object based on the motion measures.

19. The method of claim 18, further comprising generating a position map comprising ones of the position coordinates indexed by respective sets of thickness values derived from respective ones of the sets of thickness measurements.

20. The method of claim 19, further comprising identifying ones of the position coordinates from correlations between corresponding ones of the sets of thickness values in the position map with respective sets of thickness measurements, and the generating comprises producing ones of the motion measures based on the identified position coordinates.

21. The method of claim 19, further comprising deriving each of the sets of thickness values from a weighted combination of the sets of thickness measurements that are determined to have corresponding position coordinates.

22. The method of claim 13, wherein the generating comprises producing ones of the movement measures indicative of movement in relation to the object in directions along the object surface.
